(19) United States
(12) Patent Application Publication
(10) Pub. No.: US 2005/0035042 A1
(43) Pub. Date: Feb. 17, 2005

(54) Water filter cartridge

(76) Inventors: Gregory Norman Rowe, Rainham (GB); Robert Bryan Perrin, Hornchurch (GB)

Correspondence Address: GOTTLIEB RACKMAN & REISMAN PC, 270 MADISON AVENUE, 8TH FLOOR, NEW YORK, NY, 100160601, US

(21) Appl. No.: 10/495,667

(22) PCT Filed: Nov. 12, 2002
(86) PCT No.: PCT/GB02/05100

(30) Foreign Application Priority Data
Nov. 12, 2001 (GB) 0127128.7

(51) Int. Cl. B01D 35/14

(52) U.S. Cl. 210/234; 210/235

(57) ABSTRACT

A water filter comprises a cap (70) having an inlet (84) and an outlet (74), a valve (88) being provided in the inlet (84). A housing (10) has a filter cartridge (26) removably contained in the housing. Valve opening means in the form of a ramp like projection (56) is provided on an upper end cap (40) of the filter cartridge (26). The housing is connected to the cap by a bayonet fitting. When the housing (10) is rotated to connect to the cap (70), the cartridge (26) is also rotated, and the projection (56) contacts the valve member (96) to open the valve.

The present invention relates to a water filter cartridge.

Water filters are now widely used in the domestic environment. Typically, a filter is placed inline between a main water supply and a tap or fountain on the kitchen worktop, adjacent the sink or basin, the filter being housed in the kitchen unit, below the worktop.

One product, marketed by WTC Ecomaster Corporation of Minneapolis, Minn., comprises a cap which is mounted in-line with the water supply, and a replaceable filter unit which is a bayonet fit to the cap. The filter unit is a plastics housing enclosing a body of filter material. The cap has a water inlet, feeding water from the mains supply through a waterway and down into the housing, water passes through the filter body in the housing and then back up to an outlet in the cap, which is connected to the tap. To facilitate replacement of the unit without the need to disconnect or turn off the water supply, a spring loaded valve closes the water inlet in the cap. As the unit is twisted into position in the cap to engage the bayonet fitting, a cam in the housing lifts the valve against the spring to open the waterway. Similarly, when the unit is untwisted, the cam allows the valve to drop, closing the waterway. One difficulty with this system is that it is wasteful of material. The plastic housing is substantial in order to resist distortion under high water pressure up to 120 psi. It must also be sealed around the water filter material in the housing during manufacture and so the complete unit, housing and filter material, is disposed of. The top of the housing is a complex moulding, incorporating both the cam and bayonet fittings. Also, the user cannot usually inspect the filter material (inspection may reveal nothing to the user, but users may want to comfort of seeing the filter material).

Another product which has been marketed for many years in combination with a tap for delivering hot, cold and filtered water, under the trade mark TRIFLOW and marketed by FRANKE AG of Switzerland, utilises a cylindrical housing with a drop in filter cartridge. The housing screws into a cap which is connected in line with the water supply. This product has the advantage that only the cartridge is replaced, however it is necessary to provide a manually operated tap or valve upstream of the cap, to turn off the water supply when changing the cartridge.

The present invention provides a water filter comprising a cap for connection in-line with a water supply, the cap having an inlet water way including a valve and a water outlet, a housing connectable to the cap, and a filter cartridge which is removably contained in the housing, wherein valve opening means is provided on an upper end of the filter cartridge to open the valve when the housing is connected to the cap.

Thus, only the filter cartridge needs to be disposed of, while the benefit of automatically shutting of the water supply is provided.

Also, by providing the cam on the filter cartridge, not the housing, the user cannot install an empty housing—as the valve will remain closed.

Preferably the valve opening means is a projection on the end of the filter cartridge. Preferably the cartridge is keyed to the housing so that the cartridge will rotate with the housing, and the projection on the cartridge is in the form of a cam or ramp to engage and open the valve as the cartridge is rotated.

The invention also provides a filter cartridge having the projection at one end thereof.

The invention will be further described by way of example, with reference to the accompanying drawings, in which:

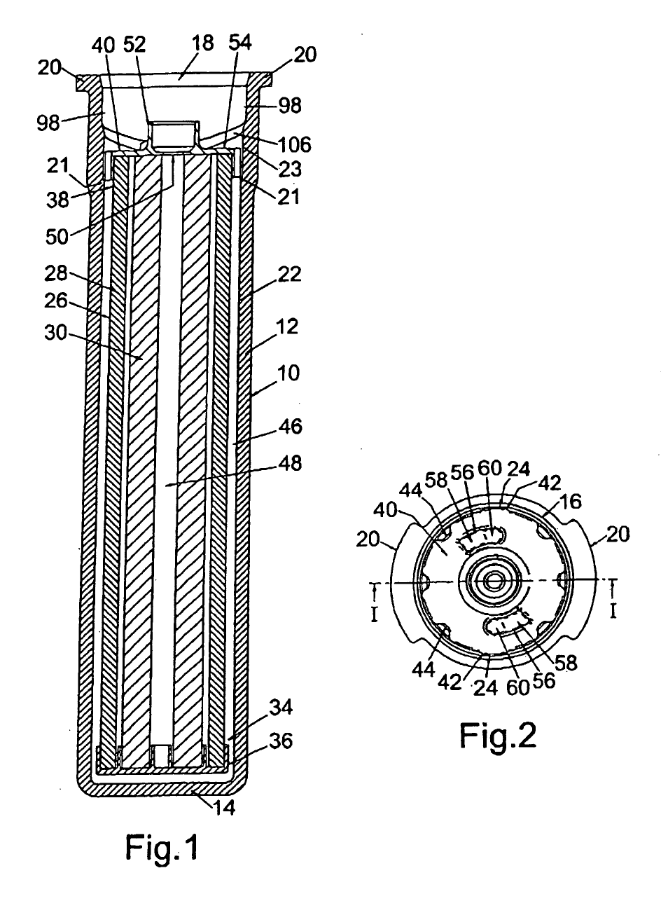

FIG. 1 is a cross-section through a housing and cartridge of a water filter in accordance with the invention, along line I-I of FIG. 2;

FIG. 2 is a plan view of the housing and cartridge of FIG. 1;

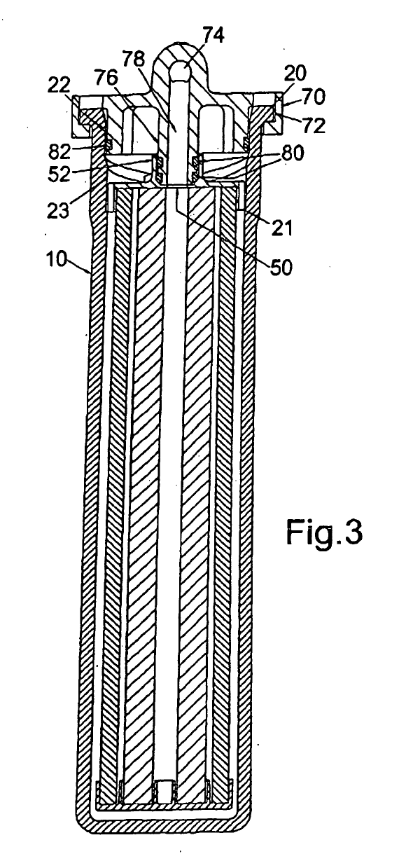

FIG. 3 is a cross-section through the water filter with the cap in place, along line I-I of FIG. 2,

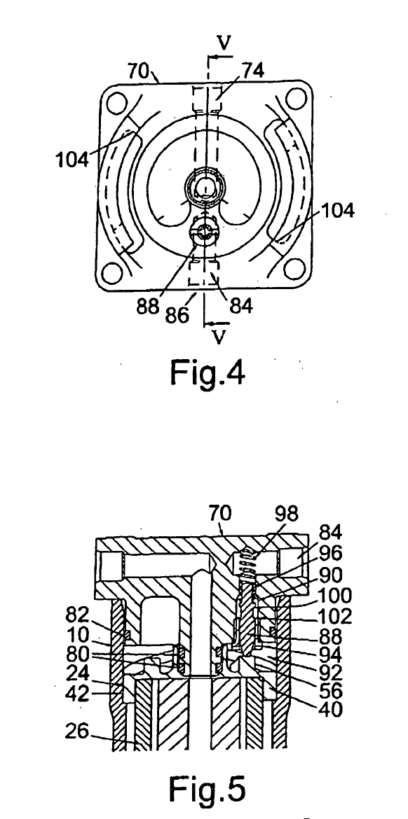

FIG. 4 is an underneath view of the cap; and

FIG. 5 is an enlarged, partial cross-section through the water filter along line V-V of FIG. 4.

Referring to FIGS. 1 and 2, a housing 10, which may be integrally moulded of plastics material, comprises a circular cross-section cylindrical tube wall 12 closed by a bottom wall 14. A peripheral lip 16 encircles the top, open end 18 of the tube and two opposed lugs 20 extend outwards to form a bayonet coupling to a cap (vide hereinafter). An inner surface 22 of wall 12, has a step 21 to form a larger diameter upper region 23, in which two diametrically opposed recesses 24 are formed (see FIG. 5).

A filter cartridge 26 is suspended in the housing 10. Cartridge 26 comprises a circular cross-section outer sleeve 28 of porous filter material such as a ceramic, and a circular cross-section inner sleeve 30 of porous carbon filter material, such materials are well known in the art. Sleeve 28 is capped at its lower end 34 by a plastics base 36, and at its upper end 38 by a cap 40. Cap 40 is supported on step 21 and has protrusions 42 which engage in the recesses 24 in wall region 23.

Cap 40 is a loose fit in the tube 12, but dimensioned so that protrusions 42 engage with recesses 24 to ensure that the cap 40 and so the complete cartridge 26 will rotate with the housing 10. Cap 40 has recesses 44 in its outer periphery (FIG. 2) to form channels between the cap 40 and the wall surface 23 for water to flow into the space 46 between sleeve 28 and wall 12. Water passes, under pressure, through sleeves 28, 30 into the inner space 48 and out through an aperture 50 in cap 40. A stub sleeve 52 surrounds aperture 50 on the upper surface 54 of cap 40.

Also provided on the upper surface 54 of cap 40 are two cams 56. Each cam has a sloping surface 58 leading to a flat or horizontal surface 60, i.e. parallel to surface 54.

Referring to FIG. 3, a cap 70 which may be moulded of plastics material is fitted on the housing 10. Cap 70 has internally facing arcuate recesses 72 for receiving the lugs 20 to provide a bayonet fitting. Also seen in FIG. 3 is an outlet waterway 74 which extends from the centre of the cap 70 to the outer edge for connection to a pipe leading to a tap. Waterway 74 connects with outlet aperture 50 via a channel 78 in a spigot 76 which is sealed to cylinder 52 by two O-ring seal 80. Cap 70 seals with inner surface 22 of housing 10 by an O-ring seal 82.

FIG. 4 is an underneath view of cap 70 showing outlet water way 74. Waterway 74 may be threaded at its outer end to receive a pipe connector. Also shown is an inlet waterway 84 which extends from the outer periphery 86 of cap 70 to a spring-loaded poppet valve 88.

Referring to FIG. 5, which is a cross-section at right angles to FIG. 3, inlet waterway 84 ends in a passage 90 which connects with the space 92 above cap 40, via poppet valve 88. Valve 88 comprises a valve seat 94 which is screwed into the cap 70, trapping a valve member 96. Valve member 96 is biassed by a spring 98 towards valve seat 94. A conical surface 100 on member 96 engages a surface 102 on valve seat 94 to form a seal. An O-ring (not shown) will be interposed between surfaces 100, 102, carried loosely on valve member 96 to form a seal.

In FIG. 5, the housing 10 and cartridge 26 have been installed in the cap and rotated to the locked position, bayonet lugs 20 abutting stops 104 (see FIG. 4) when the bayonet fitting is rotated fully home. One of the ramps 56 has lifted valve member 96 to open the valve 88, allowing water to flow.

With the cap 70 installed in-line between the water supply and a tap, when housing 10 and cartridge 26 are removed, spring 98 and the water pressure push valve member 96 onto valve seat 94, preventing water escaping through passage 90. To install a filter cartridge, cartridge 26 is placed in housing 10, the protrusions 42 and recesses 24 aligning the cartridge cap 40 and hence cams 56, relative to bayonet lugs 20. To facilitate location of the cartridge 26 as it is ‘dropped’ in the housing 10, the upper inner wall region 98 is enlarged an a ramp 106 forms a junction with region 23, sloping down to the upper end of the recesses 24. The cartridge and housing are raised in position, lugs 20 passing between the sockets 72. The cap 70 seals against housing 10 and cartridge 26 with ‘0’ ring seals 80, 82. Housing 10, and hence also cartridge 26, is then rotated to engage the bayonet lugs 20 in sockets 72. At about 45 to 60 degrees of rotation, ramp 58 of cam 56 engages the bottom end valve member 96. At 60 to 90 degrees rotation, the cam 56 has lifted valve member 96 so that it rests on flat surface 60 of cam 56, and is fully open, as seen in FIG. 5.

By providing a rotationally symmetric fitting, the cartridge 26 can be fitted in either of two positions in housing 10, and housing 10 can engage cap 70 in either of two positions. It will be appreciated that the shapes may be altered to ensure that the parts always engage in one configuration only, or in more than two.

The cartridge 26 may be keyed to the housing 10 in other ways.

Other modifications will be apparent to those skilled in the art.

1. A water filter comprising a cap having an inlet and an outlet, a valve being provided in the inlet, a housing connectable to the cap to close an open end of the housing, and a filter cartridge removably contained in the housing, and valve opening means being provided on an upper end of the filter cartridge at the open end of the housing, wherein when the housing is connected to the cap, the valve opening means opens the valve, and when the housing is disconnected, the valve closes.

2. A filter as claimed in claim 1, wherein the valve opening means is a projection on an end of the filter cartridge.

3. A filter as claimed in claim 1 or 2, wherein the valve is biassed to the closed position.

4. A filter as claimed in claims 1, 2 or 3, wherein the housing is rotated relative to the cap to connect the housing to the cap, and the valve opening means engages the valve member as the housing is rotated.

5. A filter as claim in claim 4, wherein a bayonet fitting is provided for connecting the housing and the cap.

6. A filter as claimed in claim 4 or 5, wherein the valve opening means has a sloping surface and a valve member of the valve rides up the sloping surface as the housing is rotated.

7. A filter as claimed in any one of claims 1 to 6, wherein the cartridge is engaged with the housing so as to rotate therewith.

8. A filter as claimed in claim 7, wherein an inner surface of the housing and a co-operating surface on the cartridge are shaped so that the cartridge does not rotate in the housing.

9. A filter as claimed in claim 8, wherein the inner surface of the housing has a recess, and a co-operating protrusion is provided on the cartridge.

10. A filter cartridge for the water filter of any one of claims 1 to 9, the cartridge comprising a body of porous material for filtering water, the body having at one end the valve opening means, the cartridge being readily replaceably installed in use in a housing which is separable from the cartridge.

11. A water filter substantially as herein before described with reference to the accompanying drawings.

12. A filter cartridge substantially as hereinbefore described with reference to the accompanying drawings.
